(19) United States
(12) Patent Application Publication
(10) Pub. No.: US 2003/0236946 A1
(43) Pub. Date: Dec. 25, 2003

(54) Managed queues

(76) Inventor: James David Greubel, Shalimar, FL (US)

Correspondence Address: FISH & RICHARDSON PC, 225 FRANKLIN ST, BOSTON, MA, 02110, US

(21) Appl. No.: 10/176,362

(22) Filed: Jun. 20, 2002

(51) Int. Cl. G06F 12/00

(52) U.S. Cl. 711/118; 711/167

(57) ABSTRACT

A queue management process includes a memory apportionment process that divides a memory address space into a plurality of buffers. Each of these buffers has a unique memory address and the plurality of buffers forms an availability queue. A buffer enqueuing process associates a header cell with one or more of the buffers. The header cell includes a pointer for each of the buffers associated with the header cell. Each pointer indicates the unique memory address of the buffer associated with that pointer.

### TECHNICAL FIELD

This invention relates to managed queues.

### BACKGROUND

Queues in computer systems act as temporary storage areas for computer programs operating on a computer system. Queues allow for temporary storage of queued objects when the intended process recipient of the objects is unable to process the object immediately upon arrival. For example, if a database program is receiving streaming data from a data input port of a computer system, this data can be processed upon receipt and stored on a storage device, such as a hard drive. However, if the user of the system submits a query to this database program, during the time that the query is being processed, the streaming data received from the input port is typically queued for later processing and storage by the database. Once the processing of the query is completed, the database will access the queue and start retrieving the data from the queue and storing it on the storage device. Queues are typically hardware-based using dedicated portions of memory address space (i.e., memory banks) to store queued objects.

### SUMMARY

According to an aspect of this invention, a queue management process resides on a server and includes a memory apportionment process that divides a memory address space into a plurality of buffers. Each of these buffers has a unique memory address and the plurality of buffers forms an availability queue. A buffer enqueuing process associates a header cell with one or more of the buffers. The header cell includes a pointer for each of the buffers associated with the header cell. Each pointer indicates the unique memory address of the buffer associated with that pointer.

One or more of the following features may also be included. A queue object write process writes queue objects into one or more of the buffers and a queue object read process reads queue objects stored in one or more of the buffers. The buffers associated with the header cell constitute a queue, such as a FIFO (First In, First Out) queue.

The queue objects read process is configured to sequentially read the buffers in the FIFO queue in the order in which they were written by the queue objects write process. A buffer priority process adjusts the order in which the buffers are read in accordance with the priority level of the queue objects stored within the buffers. A queue location process allows a first application to determine the starting address of a queue created for a second application so that the first application can access that queue.

A buffer dequeuing process, which is responsive to the queue object read process reading queue objects stored in the buffers, dissociates the buffers from the header cell and releases them to the availability queue. The queue management process includes a buffer deletion process that deletes the buffers when they are no longer needed by the queue management process. A buffer configuration process determines the queue parameters for an application using the queue management process. These queue parameters include a queue starting address, a queue depth parameter, and a queue entry size parameter. When the memory apportionment process divides the memory address space into the plurality of buffers, it does so in accordance with these queue parameters.

According to a further aspect of this invention, a queue management method includes dividing a memory address space into a plurality of buffers. Each buffer has a unique memory address and the plurality of buffers forms an availability queue. A header cell is associated with the buffers. This header cell includes a pointer for each of the buffers associated with the header cell, such that each pointer indicates the unique memory address of the buffer associated with that pointer.

One or more of the following features may also be included. Queue objects are written into and read from the buffers. The buffers associated with the header cell constitute a queue, such as a FIFO (First In, First Out) queue. Reading queue objects stored in the buffers is configured to sequentially read the buffers in a FIFO queue in the order in which they were written. The order in which the buffers are read is adjusted in accordance with the priority level of the queue objects stored within the buffers. A first application is allowed to determine the starting address of a queue created for a second application, so that the first application can access the queue. The buffers are dissociated from the header cell and released to the availability queue. The buffers are deleted when they are no longer needed by the queue management method. The queue parameters for an application using the queue management method are determined. These queue parameters include a queue starting address, a queue depth parameter, and a queue entry size parameter. When the memory address space is divided into the plurality of buffers, it is done in accordance with these queue parameters.

According to a further aspect of this invention, a computer program product resides on a computer readable medium and has a plurality of instructions stored on it. When executed by the processor, these instructions cause that processor to divide a memory address space into a plurality of buffers, each of which has a unique memory address. The plurality of buffers forms an availability queue. A header cell is associated with one or more of the buffers, such that each header cell includes a pointer for each of the buffers associated with that header cell. Each pointer indicates the unique memory address of the buffer associated with that pointer.

One or more advantages can be provided from the above. Queues can be dynamically configured in response to the number and type of applications running on the system. Accordingly, system resources can be conserved and memory usage made more efficient. Further, queues can be modified in response to variations in the usage of an application, thus allowing the queues to be dynamically reconfigured while the application and/or operating system is running.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of a queue management process; and

FIG. 2 is a flow chart depicting a queue management method.

### DETAILED DESCRIPTION

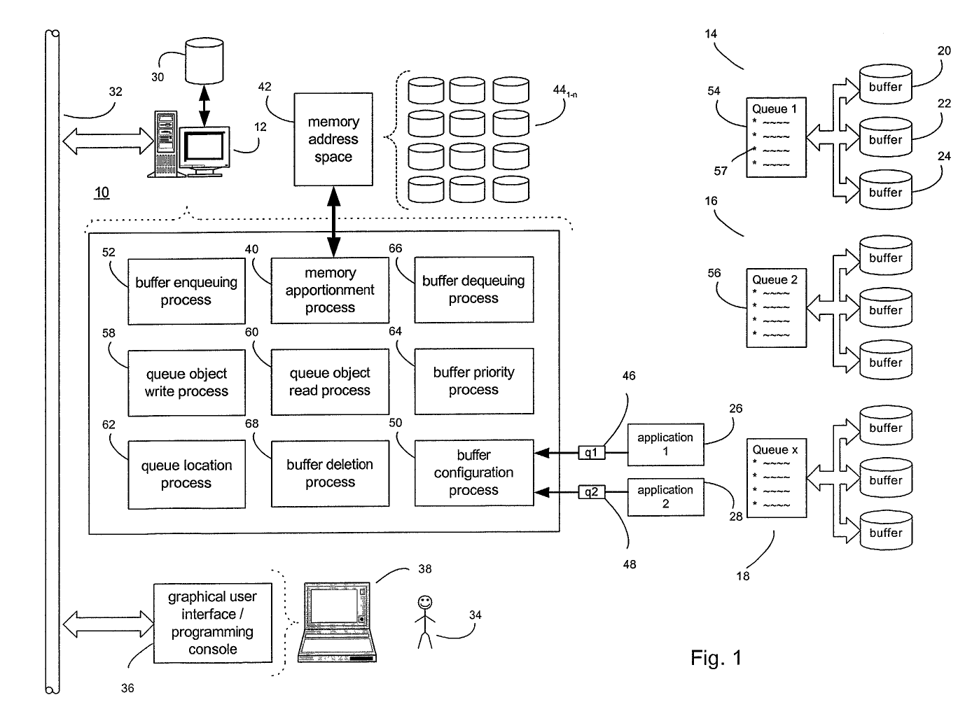

Referring to FIG. 1, there is shown a process 10, which resides on server 12 and manages queues (e.g., queues 14, 16, 18 ). These queues 14, 16, 18, which are made up of individual buffers (e.g., buffers 20, 22, 24 for queue 12 ), are dynamically configured by process 10 in response to the needs of the applications 26, 28 running on server 12.

Process 10 typically resides on a storage device 30 connected to server 12. Storage device 30 can be a hard disk drive, a tape drive, an optical drive, a RAID array, a random access memory (RAM), or a read-only memory (ROM), for example. Server 12 is connected to a distributed computing network 32 that can be the Internet, an intranet, a local area network, an extranet, or any other form of network environment.

Process 10 is typically administered by an administrator 34. Administrator 34 may use a graphical user interface or a programming console 36 running a remote computer 38, which is also connected to network 32. The graphical user interface can be a web browser, such as Microsoft, Internet Explore™ or Netscape Navigator™. The programming console can be any text or code editor coupled with a compiler (if needed).

Process 10 includes a memory apportionment process 40 for dividing a memory address space 42 into multiple buffers 44₁₋ₙ. These buffers 44₁₋ₙ will be used to assemble whatever queues 14, 16, 18 are required by applications 26, 28.

Memory address space 42 can be any type of memory storage device such as DRAM (dynamic random access memory), SRAM (static random access memory), or a hard drive, for example. The quantity and size of buffers 44₁₋ₙ created by memory apportionment process 40 varies depending on the individual needs of the applications 26, 28 running on server 12 (to be discussed below in greater detail).

Since each of the buffers 44₁₋ₙ represents a physical portion of memory address space 42, each buffer has a unique memory address associated with it, namely the physical address of that portion of memory address space 42. Typically, this address is an octal address. Once memory address space 42 is divided into buffers 44₁₋ₙ, this pool of buffers is known as an availability queue, as this pool represents the buffers available for use by queue management process 10.

Upon the startup of an application 26, 28 running on server 12 (or upon the booting of server 12 itself), the individual queue parameters 46, 48 of the applications 26, 28 respectively running on the server are determined. These queue parameters 46, 48 include the starting address for the queue (typically an octal address), the depth of the queue (typically in words), and the width of the queue (typically in words). These words are referred to as queue objects that may be, for example, system commands or chunks of data provided by an application running on server 12.

Process 10 includes a buffer configuration process 50 that determines these queue parameters 46, 48. While two applications 26, 28 are shown, this is for illustrative purposes only, as the number of applications deployed on server 12 varies depending on the particular use and configuration of server 12. Additionally, the process 50 is performed for each application running on server 12. For example, if application 26 requires ten queues and application 28 requires twenty queues, buffer configuration process 50 would determine the queue parameters for thirty queues, in that application 26 would provide tens sets of queue parameters and application 28 would provide twenty sets of queue parameters.

Typically, when an application is launched (i.e., loaded), that application proactively provides the queue parameters 46, 48 to buffer configuration process 50. Alternatively, these queue parameter 46, 48 may be reactively provided to buffer configuration process 50 in response to process 50 requesting them.

Concerning these queue parameters, the applications 26, 28 usually each include a batch file that executes when the application launches. The batch files specify the queue parameters (or the locations thereof) so that the parameters can be provided to buffer configuration process 50. Further, this batch file for each application 26, 28 may be reconfigured and/or re-executed in response to changes in the application's usage, loading, etc. For example, assume that the application in question is a database and the queuing requirements of this database are proportional to the number of records within the database. Accordingly, as the number of records increase, the number and/or size of the queues should also increase. Therefore, the batch file that specifies (or includes) the queuing requirements of the database may re-execute when the number of records in the database increases to a level that requires enhanced queuing capabilities. This allows for the queuing to dynamically change without having to relaunch the application, which is usually undesirable in a server environment.

Once the queue parameters 46, 48 for the applications 26, 28 are received by buffer configuration process 50, memory apportionment process 40 divides memory address space 32 into the appropriate number and size of buffers. For example, if application 26 requires one queue (Queue 1) that includes four, one-word buffers; the queue depth of Queue 1 is four words and the queue width (i.e., the buffer size) is one word. Additionally, if application 28 requires one queue (Queue 2) that includes eight, one-word buffers; the queue depth of Queue 2 is eight words and the queue width is one word. Summing up:

| Queue Name | Queue Width (in words) | Queue Depth (in words) |
|---|---|---|
| Queue 1 | 1 | 4 |
| Queue 2 | 1 | 8 |

Upon determining the parameters of the two queues that are needed (one of which is four words deep and another eight words deep), twelve one-word buffers 44₁₋ₙ are carved out of memory address space 32 by memory apportionment process 40. These twelve one-word buffers are the availability queue for process 10. Note that since twelve buffers are needed, only twelve buffers are created and the entire memory address space 32 is not carved up into buffers. Therefore, the remainder of memory address space 32 can be used by other programs for general “non-queuing” storage functions.

Continuing with the above-stated example, if memory address space 32 is two-hundred-fifty-six-kilobytes of SRAM, the address range of that address space is 000000-777777_{base 8}. Since each of these twelve buffers is configured dynamically in memory address space 32 by memory apportionment process 40, each buffer has a unique starting address within that address range of memory address space 32. For each buffer, the starting address of that buffer in combination with the width of the queue (i.e., that queue's buffer size) maps the memory address space of that buffer. Let's assume that server 12 is a thirty-two bit system and, therefore, each thirty-two bit data chunk is made up of four eight-bit words. Assuming that memory apportionment process 40 assigns a starting memory address of 000000_{base 8} for Buffer 1, for the twelve buffers described above, the memory maps of their address spaces is as follows:

| Buffer | Starting Address_{base 8} | Ending Address_{base 8} |
|---|---|---|
| Buffer 1 | 000000 | 000003 |
| Buffer 2 | 000004 | 000007 |
| Buffer 3 | 000010 | 000013 |
| Buffer 4 | 000014 | 000017 |
| Buffer 5 | 000020 | 000023 |
| Buffer 6 | 000024 | 000027 |
| Buffer 7 | 000030 | 000033 |
| Buffer 8 | 000034 | 000037 |
| Buffer 9 | 000040 | 000043 |
| Buffer 10 | 000044 | 000047 |
| Buffer 11 | 000050 | 000053 |
| Buffer 12 | 000054 | 000057 |

Since, in this example, the individual buffers are each thirty-two bit buffers (comprising four eight-bit words), the address space of Buffer 1 is 000000-000003_{base 8}, for a total of four bytes. Therefore, the total memory address space used by these twelve buffers is forty-eight bytes and the vast majority of the two-hundred-fifty-six kilobytes of memory address space 32 is not used. However, in the event that additional applications are launched on server 12 or the queuing needs of applications 26, 28 changes, additional portions of memory address space 32 will be subdivided into buffers.

At this point, an availability queue having twelve buffers is available for assignment. A buffer enqueuing process 52 assembles the queues required by the applications 26, 28 from the buffers 44₁₋ₙ available in the availability queue. Specifically, buffer enqueuing process 52 associates a header cell (a.k.a. a queue cell) with one or more of these twelve buffers 44₁₋ₙ. These header cells 54, 56 are addressable lists that provide information (in the form of pointers 57) concerning the starting addresses of the individual buffers that make up the queues.

Continuing with the above-stated example, Queue 1 is made of four one-word buffers and Queue 2 is made of eight one-word buffers. Accordingly, buffer enqueuing process 52 may assembly Queue 1 from Buffers 1-4 and assemble Queue 2 from Buffers 5-12. Therefore, the address space of Queue 1 is from 000000-000017_{base 8}, and the address space of Queue 2 is from 000020-000057_{base 8}. The content of header cell 54 (which represents Queue 1, the four word queue) is as follows:

Queue 1

000000
000004
000010
000014

The values 000000, 000004, 00010, and 000014 are pointers that point to the starting address of the individual buffers that make up Queue 1. Note that these values do not represent the content of the buffers themselves and are only pointers that point to the buffers containing the queue objects. To determine the content of the buffer, the application would have to access the buffer referenced by the appropriate pointer.

The content of header cell 56 (which represents Queue 2, the eight word queue) is as follows:

Queue 2

000020
000024
000030
000034
000040
000044
000050
000054

Typically, the queue assembly handled by buffer enqueuing process 52 is performed dynamically. That is, while the queues were described above as being assembled prior to being used, this was done for illustrative purposes only, as the queues are typically assembled on an “as needed” basis. Specifically, header cells 54, 56 (with the exception of the header that specifies the name of the header cell, i.e., Queue 1 and Queue 2) would be empty. For example, header cell 54, which represents Queue 1 (the four word queue), would be an empty table that includes four place holders into which the addresses of the specific buffers used to assemble that queue will be inserted. However, these address are typically not added (and therefore, the buffers are typically not assigned) until the buffer in question is written to. Therefore, an empty buffer is not referenced in a header cell and not assigned to a queue until a queue object is written into it. Until this write procedure occurs, these buffers remain in the availability queue.

Continuing with the above-stated example, when an application wishes to write to a queue (e.g., Queue 1), that application references that queue by the header (e.g., “Queue 1”) included in the appropriate header cell 54. When a queue object is received from the application associated with the header cell 54 (e.g., application 26 for Queue 1), buffer enqueuing process 52 first obtains a buffer (e.g., Buffer 1) from the availability queue and then the queue object received is written to that buffer. Once this writing procedure is completed, header cell 54 is updated to include a pointer that points to the address of the buffer (e.g., Buffer 1) recently associated with that header cell. Further, once this buffer (e.g., Buffer 1) is read by an application, that buffer is released from the header cell 54 and is placed back into the availability queue. Accordingly, the only way in which every buffer in the availability queue is used is if every buffer is full and waiting to be read. Concerning buffer read and write operations, a queue object write process 58 writes queue objects into buffers 44₁₋ₙ and a queue object read process 60 reads queue objects stored in the buffers.

Typically, the queues created by an application are readable and writable only by the application that created the queue. However, these queues may be configured to be readable and/or writable by any application, regardless of whether or not they created the queue. If this cross-application access is desired, process 10 includes a queue location process 62 that allows an application to locate a queue (provided the name of the header cell associated with that queue is known) so that the application can access that queue.

Typically, the access level of the second application is limited to only being able to read the first buffer associated with the queue in question. This limited access is typically made possible by providing the second application with the memory address (e.g., 000000_{base 8} for Buffer 1, the first buffer in Queue 1) of the first buffer of the queue.

Queues assembled by buffer enqueuing process 52 are typically FIFO (first in, first out) queues, in that the first queue object written to the queue is the first queue object read from the queue. However, a buffer priority process 64 allows for adjustment of the order in which the individual buffers within a queue are read. This adjustment can be made in accordance with the priority level of the queue objects stored within the buffers. For example, higher priority queue objects could be read before lower priority queue objects in a fashion similar to that of interrupt prioritization within a computer system.

As stated above, when a buffer within a queue is read by queue object read process 60, that buffer is typically released back to the availability queue so that future incoming queue objects can be written to that buffer. A buffer dequeuing process 66, which is responsive to the reading of a queue object stored in a buffer, dissociates that recently read buffer from the header cell. Accordingly, continuing with the above stated example, once the content of Buffer 1 is read by queue object read process 60, Buffer 1 would be released (i.e., dissociated) and, therefore, the address of Buffer 1 (i.e., 000000_{base 8}) that was a pointer within header cell 54 is removed. Accordingly, after buffer dequeuing process 66 removes this pointer (i.e., the address of Buffer 1) from header cell 54, this header cell 54 is once again empty.

Note that header cell 54 is capable of containing four pointers which are the four addresses of the four buffers associated with that header cell and, therefore, Queue 1. When Queue 1 is empty, so are the four place holders that can contain these four pointers. As queue objects are received for Queue 1, queue object write process 58 writes each of these queue objects to an available buffer obtained from the availability queue. Once this write process is complete, buffer enqueuing process 52 associates each of these now-written buffers with Queue 1. This association process includes modifying the header cell 54 associated with Queue 1 to include a pointer that indicates the memory address of the buffer into which the queue object was written. Once this queue object is read from the buffer by queue object read process 60, the pointer that points to that buffer will be removed from header cell 54 and the buffer will once again be available in the availability queue. Therefore, header cell 54 only contains pointers that point to buffers containing queue object that need to be read. Accordingly, for header cell 54 and Queue 1, when Queue 1 is full, header cell 54 contains four pointers, and when Queue 1 is empty, header cell 54 contains zero pointers.

As the header cells incorporate pointers that point to queue objects (as opposed to incorporating the queue objects themselves), transferring queue objects between queues is simplified. For example, if application 26 (which uses Queue 1 ) has a queue object stored in Buffer 3 (i.e., 000010_{base 8}) and this queue object needs to be processed by application 28 (which uses Queue 2), buffer dequeuing process 64 could dissociate Buffer 3 from the header cell 54 for Queue 1 and buffer enqueuing process 52 could then associate Buffer 3 with header cell 56 for Queue 2. This would result in header cell 54 being modified to remove the pointer that points to memory address 000010_{base 8} and header cell 56 being modified to add a pointer that points to 00010_{base 8}. This results in the queue object in question being transferred from Queue 1 to Queue 2 without having to change the location of that queue object in memory.

In the event that the queuing needs of an application are reduced or an application is closed, the header cell(s) associated with this application would be deleted. Accordingly, when header cells are deleted, the total number of buffers required for the availability queue are also reduced. Accordingly, a buffer deletion process 68 deletes these buffer so that these portions of memory address space 32 can be used by some other storage procedure.

Continuing with the above example, if application 28 was closed, header cell 56 would no longer be needed. Additionally, there would be a need for eight less buffers, as application 56 specified that it needed a queue that was one word wide and eight words deep. Accordingly, eight one-word buffers would no longer be needed and buffer deletion process 68 would release eight buffers (e.g., Buffers 5-12) so that these thirty-two bytes of storage would be available to other programs or procedures.

While the buffers 44₁₋ₙ are described above as being one word wide, this is for illustrative purposes only, as they may be as wide as needed by the application requesting the queue.

While above, Queues 1 & 2 are described as being one buffer wide, this is not intended to be a limitation of the invention. Specifically, the application can specify that the queues it needs can be as wide or as narrow as desired. For example, if a third application (not shown) requested a queue that was eight words deep but two words wide, a total of sixteen buffers would be used having a total size of sixty-four bytes, as each thirty-two bit buffer of four one-byte words. The header cell (not shown) associated with Queue 3 would have place holders for only eight pointers. Therefore, each pointer would point to the beginning of a two buffer storage area. Accordingly, the starting address of the second buffer of each two buffer storage area would not be immediately known nor directly addressable. Naturally, this third application would have to be configured to process data in two word chunks and, additionally, write process 58 and read process 60 would have to be capable of respectively writing and reading data in two word chunks.

Note that the buffer availability queue described above has multiple buffers, each of which has the same width (i.e., one word). While all the buffers in an availability queue have the same width, process 10 allows for multiple availability queues, thus accommodating multiple buffer widths. For example, if the third application described above had requested a queue that was two words wide and eight words deep, memory address space 32 could be apportioned into eight two-word chunks in addition to the one-word chunks used by Queues 1 & 2. The one-word buffers would be placed into a first availability queue (for use by Queues 1 & 2) and the two-word buffers would be placed into a second availability queue (for use by Queue 3). When a queue object is received for either Queues 1 or 2, buffer enqueuing process 52 would obtain a one-word buffer from the first availability queue. Alternatively, when a queue object is received for Queue 3, buffer enqueuing process 52 would obtain a two-word buffer from the second availability queue.

As described above, each buffer has a physical address associated with it, and that physical address is the address of the buffer within the memory storage space 32. In the beginning of the above-stated example, Queue 1 has four buffers (i.e., Buffers 1-4) having an address range from 000000-000017_{base 8} and Queue 2 was described as having eight buffers (i.e., Buffers 5-12) having an address range from 000020-000057_{base 8}. Therefore, the starting address of Queue 1 is 000000_{base 8} and the starting address of Queue 2 is 000020_{base 8}. Unfortunately, some programs may have certain limitations concerning the addresses of the memory devices they can write to. If applications 26 or 28 have any limitations concerning the memory addresses of the buffers used to assemble their respective queues, memory apportionment process 40 is capable of translating the address of any buffer to accommodate the specific address requirements of the application that the queue is being assembled for. The amount of this translation is determined by the queue parameter that specifies the starting address of the queue (as provided to buffer configuration process 50 ). For example, if it is determined from the starting address queue parameter that application 28 (which owns Queue 2) can only write to queues having addresses greater than 100000_{base 8}, the addresses of the buffers associated with Queue 2 can all be translated (i.e., shifted upward) by 100000_{base 8}. Therefore, the addresses of Queue 2 would be as follows:

Queue 2

| Actual Memory Address | Translated Memory Address |
|---|---|
| 000020 | 100020 |
| 000024 | 100024 |
| 000030 | 100030 |
| 000034 | 100034 |
| 000040 | 100040 |
| 000044 | 100044 |
| 000050 | 100050 |
| 000054 | 100054 |

By allowing this translation, application 28 can think it is writing to memory address spaces within its range of addressability, yet the buffers actually being written to and/or read from are outside of the application's range of addressability. Naturally, the translations amount (i.e., 100000_{base 8}) would have to be known by both the write process 58 and the read process 60 so that any read or write request made by application 28 can be translated from the translated address used by the application into the actual address of the buffers.

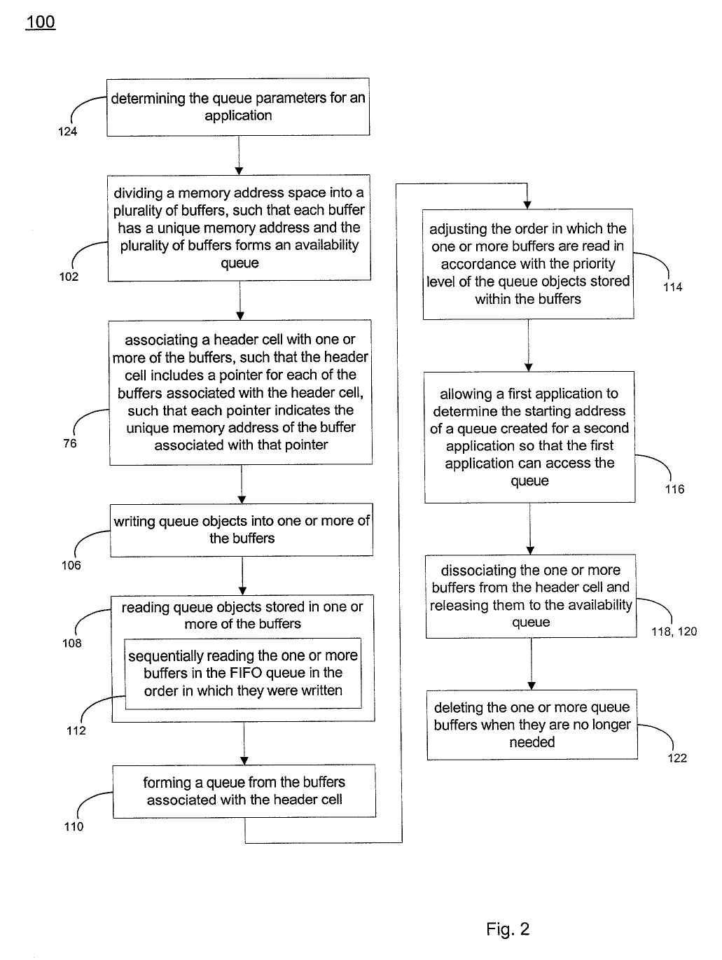

Referring to FIG. 2, a queue management method 100 is shown. A memory address space is divided 102 into a plurality of buffers. Each of these buffers has a unique memory address and these buffers form an availability queue. A header cell is associated 104 with one or more of these buffers. The header cell includes a pointer for each of the buffers associated with that header cell, such that each pointer indicates the unique memory address of the buffer associated with that pointer.

Queue objects are written to 106 and read from 108 these buffers. A queue, such as a FIFO (First In, First Out) queue, is formed 110 from the buffers associated with the header cell. The buffers that store the queue objects in the FIFO queue are sequentially read 112 in the order in which they were written. However, the order in which these buffers are read can be adjusted 114 in accordance with the priority level of the queue objects stored within the buffers. A first application is allowed 116 to determine the starting address of a queue created for a second application, thus allowing the first application to access that queue. The buffers are dissociated 118 from the header cell and released 120 to the availability queue. Further, the buffers are deleted 122 when they are no longer needed.

The queue parameters are determined 124 for an application. These queue parameters include: a queue starting address; a queue depth parameter; and a queue entry size parameter. When the memory address space is divided into buffers, it is done in accordance with these queue parameters.

A number of embodiments of the invention have been described. Nevertheless, it will be understood that various modifications may be made without departing from the spirit and scope of the invention. Accordingly, other embodiments are within the scope of the following claims.

What is claimed is:

1. A queue management process, residing on a server, comprising
a memory apportionment process for dividing a memory address space into a plurality of buffers, wherein each said buffer has a unique memory address and said plurality of buffers forms an availability queue; and
a buffer enqueuing process for associating a header cell with one or more of said buffers, wherein said header cell includes a pointer for each of said one or more buffers associated with said header cell, wherein each said pointer indicates the unique memory address of the buffer associated with that pointer.

2. The queue management process of claim 1 further comprising a queue object write process for writing queue objects into one or more of said buffers.

3. The queue management process of claim 1 further comprising a queue object read process for reading queue objects stored in one or more of said buffers.

4. The queue management process of claim 3 wherein said one or more buffers associated with said header cell constitute a queue.

5. The queue management process of claim 4 wherein said queue is a FIFO (first in, first out) queue.

6. The queue management process of claim 5 wherein said queue object read process is configured to sequentially read said one or more buffers in said FIFO queue in the order in which said one or more buffers were written by said queue object write process.

7. The queue management process of claim 4 further comprising a buffer priority process for adjusting the order in which said one or more buffers are read in accordance with the priority level of the queue objects stored within said one or more buffers.

8. The queue management process of claim 4 further comprising a queue location process for allowing a first application to determine the starting address of a queue created for a second application so that said first application can access said queue.

9. The queue management process of claim 3 further comprising a buffer dequeuing process, responsive to said queue object read process reading queue objects stored in said one or more buffers, for dissociating said one or more buffers from said header cell and releasing said one or more buffers to said availability queue.

10. The queue management process of claim 9 further comprising a buffer deletion process for deleting said one or more queue buffers when they are no longer needed by said queue management process.

11. The queue management process of claim 1 further comprising a buffer configuration process for determining the queue parameters for an application using said queue management process, wherein said queue parameters include:
a queue starting address;
a queue depth parameter; and
a queue entry size parameter,
wherein said memory apportionment process divides said memory address space into said plurality of buffers in accordance with said queue parameters.

12. A method of managing a comprising
dividing a memory address space into a plurality of buffers, wherein each buffer has a unique memory address and the plurality of buffers forms an availability queue; and
associating a header cell with one or more of the buffers, wherein the header cell includes a pointer for each of the buffers associated with the header cell, wherein each pointer indicates the unique memory address of the buffer associated with that pointer.

13. The queue management method of claim 12 further comprising writing queue objects into one or more of the buffers.

14. The queue management method of claim 13 further comprising reading queue objects stored in one or more of the buffers.

15. The queue management method of claim 14 wherein the one or more buffers associated with the header cell constitute a queue.

16. The queue management method of claim 15 wherein the queue is a FIFO (first in, first out) queue.

17. The queue management method of claim 16 wherein said reading queue objects stored in one or more of said buffers is configured to sequentially read the one or more buffers in the FIFO queue in the order in which the one or more buffers were written by said writing queue objects into one or more of the buffers.

18. The queue management method of claim 15 further comprising adjusting the order in which the one or more buffers are read in accordance with the priority level of the queue objects stored within the one or more buffers.

19. The queue management method of claim 15 further comprising allowing a first application to determine the starting address of a queue created for a second application so that the first application can access the queue.

20. The queue management method of claim 12 further comprising dissociating the one or more buffers from the header cell and releasing the one or more buffers to the availability queue.

21. The queue management method of claim 20 further comprising deleting the one or more queue buffers when they are no longer needed by the queue management method.

22. The queue management method of claim 12 further comprising determining the queue parameters for an application using the queue management method, wherein the queue parameters include:
a queue starting address;
a queue depth parameter; and
a queue entry size parameter,
wherein said dividing a memory address space divides the memory address space into the plurality of buffers in accordance with the queue parameters.

23. A computer program product residing on a computer readable medium having a plurality of instructions stored thereon which, when executed by the processor, cause that processor to:
divide a memory address space into a plurality of buffers, wherein each buffer has a unique memory address and the plurality of buffers provides a queue; and
associate a header cell with one or more of the buffers, wherein the header cell includes a pointer for each of the buffers associated with the header cell, wherein each pointer indicates the unique memory address of the buffer associated with that pointer.
